(19) United States
(12) Patent Application Publication
(10) Pub. No.: US 2009/0057448 A1
(43) Pub. Date: Mar. 5, 2009

(54) Portable construction waste disposal system and method thereof

(76) Inventor: William James Cadamore, IV, Freeport, PA (US)

Correspondence Address: JAMES RAY & ASSOCIATES, 2640 PITCAIRN ROAD, MONROEVILLE, PA, 15146, US

(21) Appl. No.: 11/897,801

(22) Filed: Aug. 31, 2007

(51) Int. Cl. B02C 19/00

(52) U.S. Cl. 241/101.4

(57) ABSTRACT

The present invention provides a portable system and method for disposing construction waste from interior confines of a construction site into a waste hauling container located external to and at a predetermined distance from such interior confines. The system includes a portable waste destruction apparatus which is positioned within such interior confines of such construction site and in a close proximity to a location of work for receiving such construction waste and for reducing size thereof, a flexible hose which has one end thereof engageable with the waste hauling container and a suction generating device operably connected to an opposed end of the hose and to a discharge member of the portable waste destruction apparatus for at least transporting the reduced size construction waste to such waste hauling container.

### FIELD OF THE INVENTION

The present invention relates, in general, to construction waste disposal and, more particularly, this invention relates to a portable construction waste disposal system which is suitable for use within enclosed confines of a construction site and which reduces the size of the waste prior to depositing it into a waste hauling container.

### BACKGROUND OF THE INVENTION

As is generally well known construction waste is generated during any construction activity of a new or a repair type. In new construction, such construction waste may include for example unused portions of the drywall, scraps of plywood or wood studs, scraps of electrical conduit and copper or plastic pipes. The repair work is typically characterized by removal effort of the existing materials which essentially identified as waste and which must be disposed off and is also characterized by the waste associated with use of new materials. Typically, the construction waste is deposited, usually by throwing, into an open top waste hauling container such as a well known dumpster. When the work is to be performed within the enclosed confines, the workers must hand carry the construction waste to the dumpster which is located external to such confines and typically make multiple trips in a single work day. Thus, waste disposal decreases productivity and increases overall labor costs. Furthermore, the construction waste thrown into the dumpster leaves voids in the volume of the dumpster and therefore, the weight of the deposited construction waste rarely approaches the weight hauling capabilities of the dumpster. Since dumpster fees are charged based on per use basis rather than per hauling weight basis, disposal of the construction waste is characterized by a greater than desirable cost.

Prior to the present invention, waste disposal chute systems have been utilized on some construction sites to reduce effort required to dispose construction waste from interior confines of such construction site. However, a greater than desirable effort is required to attach portions of the chute system to the side of the structure as it is being erected and subsequently remove the chute system as the construction is completed. Furthermore, the presently employed waste disposal chute systems fail to reduce cost using dumpsters.

Therefore, there is a need for an improved system and method for disposing construction waste from enclosed confines of the construction site which increase productivity and reduce waste hauling costs.

### SUMMARY OF THE INVENTION

The invention provides a portable system for disposing construction waste from interior confines of a construction site into a waste hauling container and a method of using such system. The container is positioned external to and at a predetermined distance from such interior confines. The invention discloses a waste destruction means which is positioned within such interior confines of such construction site and in a close proximity to a location of work for receiving such construction waste and for reducing size thereof. A transporting means is engageagble with the waste destruction means for at least transporting the reduced size construction waste to such waste hauling container.

### OBJECTS OF THE INVENTION

It is, therefore, one of the primary objects of the present invention to provide a system for disposing construction waste.

Another object of the present invention is to provide a system for disposing construction waste which can be employed in enclosed confines of the construction site and in a closed proximity to a location of work.

Yet another object of the present invention is to provide a system for disposing construction waste which reduces the size of the construction waste.

A further object of the present invention is to provide a system for disposing construction waste which is capable of transporting the construction waste to a waste hauling container.

Yet a further object of the present invention is to provide a system for disposing construction waste which is simple to use.

Another object of the present invention is to provide a system for disposing construction waste which is mobile.

An additional object of the present invention is to provide a system for disposing construction waste which safeguards the user during operation.

Another object of the present invention is to provide a method for using the aforedesribed system.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a side elevation view of a portable construction waste disposal system of the present invention;

FIG. 2 is a planar view of the portable construction waste disposal system of FIG. 1;

FIG. 3 is a diagram of the portable construction waste disposal system of FIG. 1;

FIG. 4 is a diagram showing use of the portable construction waste disposal system of FIG. 1 within interior confines of a construction site;

FIG. 5 is an elevation view of the portable construction waste disposal system of FIG. 1, particularly illustrating an alternative embodiment of the safety device; and

FIG. 6 is a planar view of the portable construction waste disposal system of FIG. 1, particularly illustrating a manifold device for connecting an optional dust removing device.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

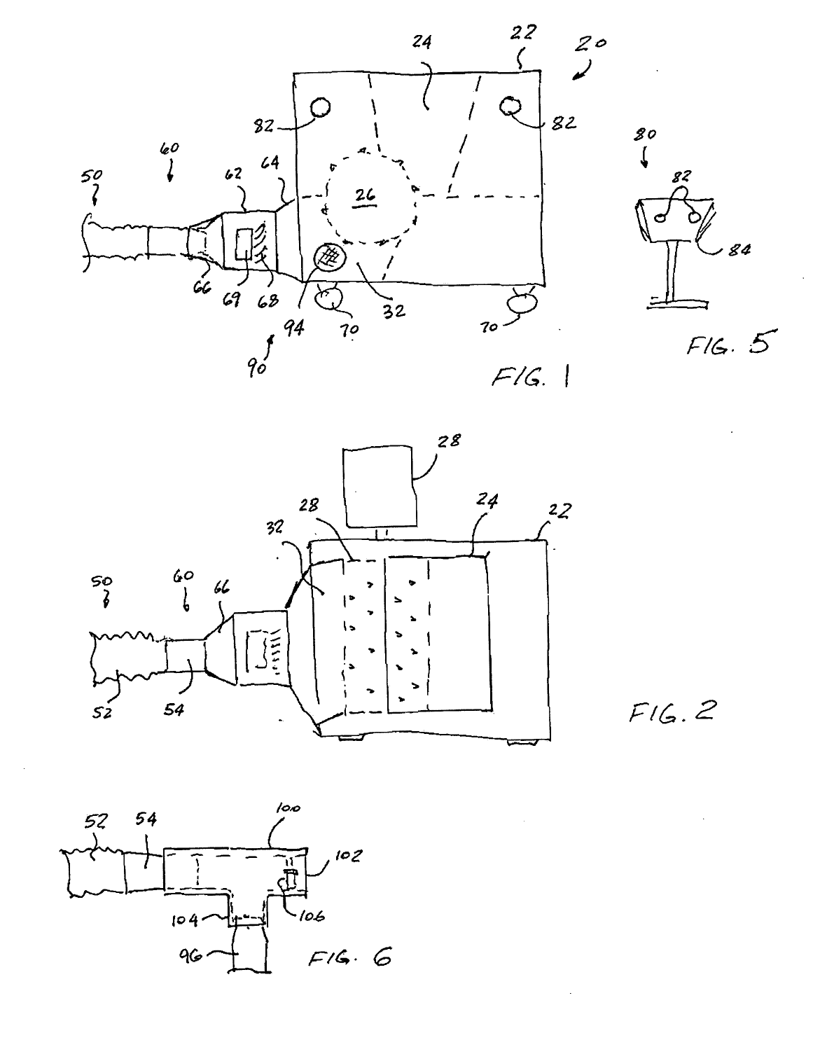

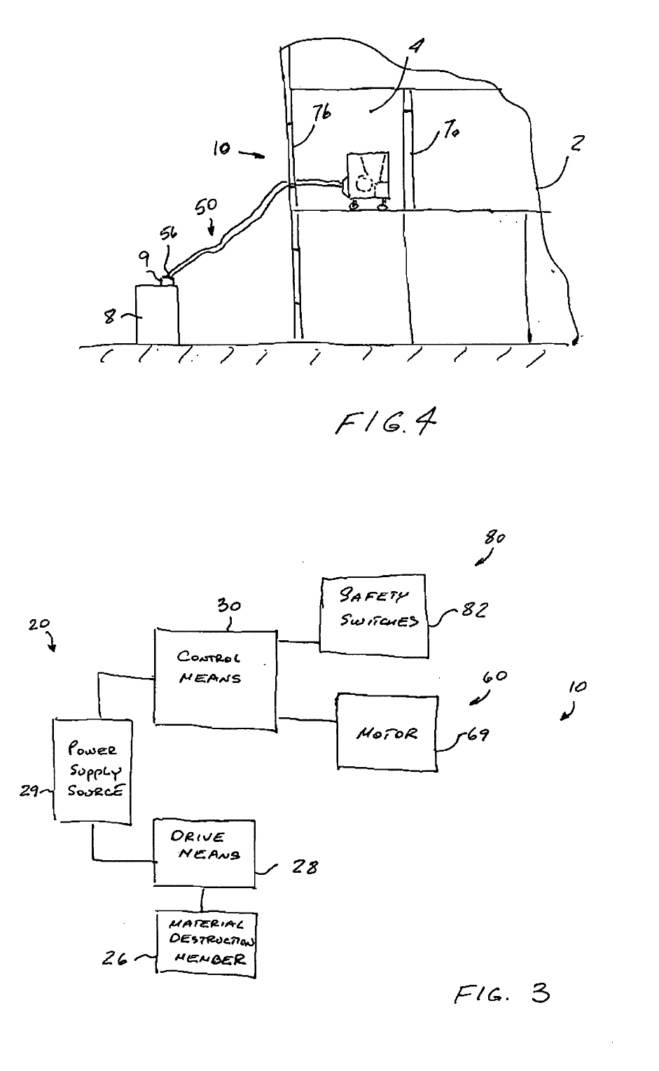

Reference is now made, to FIGS. 1-6, wherein there is shown a portable system, generally designated as 10, for disposing construction waste from interior confines 4 of a construction site 2 by depositing such construction waste material into a waste hauling container 8 which is positioned at a predetermined distance from such interior confines 4. The waste hauling container 8 may be positioned external to the interior confines 4, as best shown in FIG. 4 or it may be positioned within the interior confines 4.

The system 10 includes a waste destruction means, generally designated as 20, for receiving such construction waste material and for essentially reducing its actual size to a predetermined final size capable of being easily and simply transported. The waste destruction means 20 includes a housing 22 which has a predetermined size. An open chamber 24 is formed in the housing 20 for receiving such construction waste. A material destruction member 26 is operably mounted within the housing 22 adjacent the open chamber 24. There is a drive means 28 which is operably connected to the power supply source 29 and to the material destruction member 26 for operably moving the later to destruct the construction waste received in the chamber 24. A control means 30 is provided for operating the drive means 28. A discharge means 32 is positioned generally opposite the open chamber 24 for communicating the destructed waste material external to the housing 22.

Such waste destruction means 20 may be of a rotating drum grinding mill type disclosed in U.S. Pat. No. 2,360,357 issued to Marshal or of a hammer type grinding mill disclosed in U.S. Pat. No. 2,440,927 issued to Boss et al. Teachings of the U.S. Pat. No. 2,360,357 and U.S. Pat. No. 2,440,927 are incorporated into this document by reference thereto. It is also within the scope of the present invention to employ waste destruction means 20 of a shredder type which is suitable for shredding a portion of the construction waste, for example such as drywall.

A transporting means, generally designated as 50, is engageable with the waste destruction means 20 for at least transporting the reduced size construction waste to such waste hauling container 8. In accordance with presently preferred embodiment of the invention, the transporting means 50 includes a tubular member, preferably such as a flexible hose 52, having a first end 54 being positioned in proximity to the discharge means 32 and an opposed second end 56 being positioned in close proximity to such waste hauling container 8. When the waste hauling container 8 is positioned external to the interior confines 4, it is contemplated to provide a retractable type flexible hose 52. Means, generally designated as 60, is positioned intermediate the first end 54 of the hose 52 and the discharge means 32 of the waste destruction means 20 to generate predetermined suction power capable of thus moving the size reduced construction waste from the discharge means 32 to such waste hauling container 8 through the entire length of the hose 52.

Advantageously, such suction generating means 60 is constructed in accordance with principles employed in construction of vacuum cleaners and, according to one embodiment of the invention, includes a casing 62 having an intake port 64 which is connected, depending on the construction of the waste destruction means 20, either to the housing 22 or directly to the discharge means 32 and an exhaust port 66 which is connected to the first end 54 of the hose 52. A fan 68 is positioned within the casing 62 and in alignment with the intake port 64 and an electric motor 69 is operably connected to the fan 68 and to the control means 30 to generate such predetermined suction power capable of drawing the reduced size construction waste from the discharge means 32 through the intake port 64, directing it to the exhaust port 66 and further moving it through the hose 52.

It is also within the scope of the present invention to replace the fan 68 with a cyclone-type device to generate the required suction power.

The exhaust port 66 and the second end 56 of the hose 52 are configured for a releasable connection, preferably by a friction fit, to enable quick and simple connection thereof as well as to provide for a quick and simple disconnect effort when the waste destruction means 20 and the hose 52 are to be relocated to a different location of work. Thus, it is presently preferred to securely attach the casing 62 to the housing 22 in order to transport suction generating means 60 in combination with the waste destruction means 20.

In further reference to FIG. 4, the use of the system 10 is illustrated in combination with a construction site 2 of a building structure type, wherein the portable and power operated waste destruction apparatus 20 is first positioned within an interior room 4 and in close proximity to work being performed in such room 4. The waste hauling container 8 is shown as being positioned external to the building 2. As the construction waste is generated, it is simply deposited into the chamber 24 to be reduced in size by the material destruction member 26. Depending on the size of the chamber 24 it is contemplated to brake up the construction waste into smaller objects suitable for insertion into such chamber 24. The construction waste is then reduced into small size particles which enter the discharge means 32 and which are transported through the hose 52 due to operating suction generating means 60. The hose 52 may be simply routed through the window frame 7b of the building structure 2.

The method also provides for fixing such predetermined size of the waste destruction apparatus 20 to fit through one of a doorway 7a and a window frame 7b in order to position it in close proximity to a desired location of work and to conveniently and simply move it to a different location of work when required. Accordingly, it is within the scope of the present invention to limit weight of the waste destruction apparatus 20 so it can be manually carried to the desired location of work. If necessary, the waste destruction apparatus 20 may be constructed in a modular fashion. For example, the drive means 28 and/or the material destruction member 26 may be releaseably secured, preferably by clamping, to the housing 22 for ease of assembly and disassembly. Thus, the waste destruction apparatus 20 may be carried in a modular manner and assembled in close proximity to the desired location of work. It is also contemplated to facilitate mobility of the waste destruction means 20 for movement and repositioning between various locations of work by providing a plurality of wheels 70 being attached to the bottom portion of the housing 22, preferably at each corner thereof.

It is within the scope of the present invention to provide a safety means, generally designated as 80, which is coupled to the control means 30 for preventing insertion of user's hands or clothing into the open chamber 24. Preferably, such safety means includes a pair of spaced apart manually operable switches 82 causing the user to activate them with both hands and wherein activation of only one switch 82 disables operation of the waste destruction means 20. It is further presently preferred for the pair of switches 82 to be disposed on and secured to a predetermined portion of the housing 22 however it is within the scope of the present invention to mount such pair of switches 82 remotely from the housing 22 on a stanchion 84, as best shown in FIG. 5. Any safety switches presently employed in industrial applications for safeguarding machinery operation will be suitable in the present invention.

Although in some applications it may be adequate to transport the reduced size waste construction material to the waste hauling container 8, it may be necessary in other applications to actually deposit the reduced size construction waste into directly into such waste hauling container 8. Accordingly, the second end 56 of the hose 52 will be connected directly to such waste hauling container 8. This is advantageous when the waste hauling container 8 is a simple drum having a single inlet/outlet combination 9, as best shown in FIG. 4.

The system 10 may also includes an optional means, generally designated as 90, for removing dust particles present in vicinity of the waste destruction means 20 and for routing such dust and debris elements to the transporting means 50. It is presently preferred to construct such dust removing means 90 similar to the suction generating means 60 except for mounting its intake port 94 on the side of the housing 22 and connecting its exhaust port 96 to the hose 52 so that the dust particles can be removed independently from the operation of the suction generating means 60 and waste destruction means 20. For example the first end 54 of the hose 52 may be adapted with a simple manifold 100 having one port 102 for connection to the exhaust port 66 of the suction generating means 60 and having another port 104 for connection to the exhaust port 96 of the dust removing means 90. A damper 106 may be provided for selectively closing the port 102 to prevent dust propagation through the non-operable waste destruction means 20. Furthermore, the intake port 94 may be configured to accept cleaning accessories presently employed with the conventional vacuum cleaners thus providing for convenience of manually vacuuming dust and other debris.

Alternatively, when the dust removing means 90 is to be operated only during operation of the waste destruction means 20, the intake port 94 can be simply connected to the intake port 84 of the suction generating means 80 having the fan 88 and the motor 90 sized to generate additional suction power to remove dust form the interior confines 4 of the construction site 2.

Although, the present invention has been shown in terms of connecting the distal end of the flexible hose to a drum like container, it will be understood that such distal end can be simply positioned within the conventional dumpster which is generally positioned external to construction site 2. The waste hauling container may be also of a bag or canister type which is advantageous for positioning internal to the construction site 2 and, more particular, internal to the interior confines 4.

Furthermore, it will be understood that the construction waste material can be selectively reduced to any size capable of being drawn by the suction generating means and transported through the hose.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A portable system for disposing construction waste from interior confines of a construction site into a waste hauling container, said system comprising:
(a) a waste destruction means which is positioned within such interior confines of such construction site and in a close proximity to a location of work for receiving such construction waste and for reducing size thereof; and
(b) a transporting means which is engageagble with said waste destruction means for at least transporting said reduced size construction waste to such waste hauling container.

2. The system, according to claim 1, wherein said waste destruction means includes a housing, an open chamber formed in said housing for receiving such construction waste, a material destruction member which is operably mounted within said housing adjacent said open chamber, a drive means which is operably coupled to said material destruction member and to a power supply source for operably moving said material destruction member, a control means for operating said drive means and a discharge means for communicating said reduced size construction waste material external to said housing.

3. The system, according to claim 2, wherein said system includes a safety means disposed on and secured to a predetermined portion of said housing and coupled to said control means for preventing insertion of user's hands or clothing into said open chamber.

4. The system, according to claim 3, wherein said safety means includes a pair of spaced apart manually operable switches causing the user to activate said pair of switches with both hands and wherein activation of only one switch disables operation of said waste destruction means.

5. The system, according to claim 2, wherein said system includes a safety means positioned remotely from said housing and coupled to said control means for preventing insertion of user's hands or clothing into said open chamber.

6. The system, according to claim 2, wherein said system includes a plurality of wheels attached to a bottom portion of said housing for facilitating mobility of said waste destruction means.

7. The system, according to claim 1, wherein said transporting means includes a hose having a first end thereof being positioned adjacent a discharge means of said waste destruction means and having an opposed second end thereof positioned in close proximity to such waste hauling container, and means which is positioned intermediate of and connected to said first end of said hose and said discharge means of said waste destruction means for generating predetermined suction power capable of drawing said reduced size construction waste material from said discharge means and moving it to such waste hauling container through an entire length of said hose.

8. The system, according to claim 7, wherein said suction generating means includes:
(a) a casing having an intake port which is connected to one of said housing and said discharge means of said waste destruction means and an exhaust port which is connected to said first end of said hose;
(b) a fan which is positioned within said casing and in alignment with said intake port; and
(c) a motor which is operably connected to said fan and to said control means.

9. The system, according to claim 8, wherein said system further includes an inlet port which is formed on said housing and means for connecting said inlet port to said intake port of said suction generating means for removing dust particles present in a vicinity of said waste destruction means and for routing such dust particles to said transporting means.

10. The system, according to claim 9, wherein said inlet connection means includes a manifold having a first intake port for connection to an exhaust port of said suction generating means, a second intake port of connection to said inlet port and an exhaust port for connection to said first end of said hose.

11. The system, according to claim 10, wherein said inlet connection means further includes a damper means operably positioned therewithin for selectively closing and opening said first intake port.

12. The system, according to claim 1, wherein said system includes means disposed on and secured to said waste destruction means for removing dust particles present in a vicinity of said waste destruction means and for routing such dust particles to said transporting means.

13. The system, according to claim 12, wherein said dust removing means includes:
(a) a casing having an intake port which is mounted on said housing and an exhaust port which is connected to said first end of said hose;
(b) a fan which is positioned within said casing and in alignment with said intake port; and
(c) a motor which is operably connected to said fan and to said control means for generating suction power capable of drawing said dust particles through said intake port and transporting them through said transporting means.

14. The system, according to claim 1, wherein such waste hauling container is positioned either external or internal to such interior confines.

15. A method of disposing construction waste from interior confines of a construction site into a waste hauling container, said method comprising the steps of:
(a) reducing size of said construction waste within said interior confines and in a close proximity to a location of work; and
(b) transporting said reduced size construction waste to said waste hauling container.

16. The method, according to claim 15, wherein said method includes the additional step of connecting said transporting means to said waste hauling container and the step of depositing said reduced size construction waste thereinto.

17. The method, according to claim 15, wherein the step of reducing said size of said construction waste includes the step of providing a portable and power operated waste destruction apparatus and the step of positioning said waste destruction apparatus in said close proximity to said location of work.

18. The method, according to claim 17, wherein the step of providing said waste destruction apparatus includes the step of fixing size of said waste destruction apparatus to fit through one of a doorway and a window frame of said interior confines.

19. The method, according to claim 17, wherein the step of transporting said reduced size construction waste includes the step of connecting an intake port of a suction generating device to a discharge portion of said waste destruction apparatus, the step of connecting an exhaust port of said suction generating device to one end of a flexible hose and the step of connecting an opposed end of said hose to said waste hauling container.
